(19) United States
(12) Patent Application Publication
(10) Pub. No.: US 2010/0297910 A1
(43) Pub. Date: Nov. 25, 2010

(54) Structural Reinforcement Component For A Wooden Bee Habitat

(76) Inventor: Bob Baker, Mineral Point, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/468,330

(22) Filed: May 19, 2009

(51) Int. Cl. A01K 47/00; A01K 47/06

(52) U.S. Cl. 449/29; 449/3

(57) ABSTRACT

A selectively attachable, mass-produced component for reinforcing to man-made wooden bee habitats to counteract the effects of climates and prevent entry of invasive animals and insects components to extend the life and structural integrity of a bee habitat.

### FIELD OF INVENTION

The present invention relates to the field of apiary technology, and more specifically to a specialized component to extend the life and structural integrity of a wooden bee habitat.

### BRIEF DESCRIPTION OF THE DRAWINGS

FIG. 1a illustrates an exemplary embodiment of a reinforcement component for a wooden bee habitat adapted for use on the top left corner and edge of a hive body or honey super.

FIG. 1b illustrates an exemplary embodiment of a reinforcement component for a wooden bee habitat adapted for use on the top right corner and edge of a hive body or honey super.

FIG. 1c illustrates an exemplary embodiment of a reinforcement component for a wooden bee habitat adapted for use on a bottom edge of a hive body or honey super, or on any edge and corner of a bottom board or lid.

FIG. 2 illustrates an exemplary embodiment of reinforcement component for a wooden bee habitat in use the top right edge and corner of a hive body.

FIG. 3a illustrates a highly efficient design configuration for forming a reinforcement component for a wooden bee habitat which conforms to the dimensions of commercially available hive body or honey super components known in the art.

FIG. 3a illustrates a highly efficient design configuration for forming a reinforcement component for a wooden bee habitat which conforms to the dimensions of commercially available hive body or honey super components known in the art.

FIG. 3c illustrates a highly efficient design configuration for forming a reinforcement component for a wooden bee habitat which conforms to the dimensions of a lower corner and edge of wooden bee habitat components.

### GLOSSARY

As used herein, the term “beehive” in which honey bees live, raise their young and produce surplus honey. A beehive's internal structure is a densely packed matrix of hexagonal cells made of beeswax called a honeycomb. The bees use the cells to store food (honey and pollen), and to house the “brood” (eggs, larvae, and pupae). A beehive may be constructed by a bee colony in a natural habitat, or man-made. A beehive, whether naturally occurring or man-made, includes at least one frame and at least one cell.

As used herein, the term “frame” is a structure which supports a matrix of hexagonal cells made of beeswax within a honeycomb.

As used herein, the term “cell” is a compartment which is made of beeswax within a honeycomb, and may contain bee larvae and/or food to nourish bees.

A frame in which honey bees live, raise their young and produce surplus honey. A beehive's internal structure is a densely packed matrix of hexagonal cells made of beeswax called a honeycomb. The bees use the cells to store food (honey and pollen), and to house the “brood” (eggs, larvae, and pupae).

As used herein, the term “bee habitat” means a man-made structure to enclose multiple generations of bees in conditions that facilitate their survival, management, reproduction and breeding. A bee habitat includes structural components to emulate the hive, frame and cell components that bees create in their natural habitats. A bee habitat may include, but is not limited to, the following structural components: a bottom board, one or more hive bodies, one or more honey supers and/or a lid.

As used herein, the term “bottom board” is the bottom portion comprised of a bottom surface and at least three vertical side structures. The three side structures partially encloses the bottom portion of a bee habitat. The unenclosed side forms a opening for the exit and entry of bees from the bee habitat.

As used herein, the term “hive body” is a four sided frame structure that may be used as a modular component of a bee habitat.

As used herein, the term “honey super” means a four sided frame structure that can used as a component of a bee habitat, and which is smaller than a hive body, but which functions solely to store honey produced by the bee colony. Generally a bee queen is precluded from entering the honey super portion of a bee habitat by a queen excluding grid which is placed between a hive body and a honey super that contains openings too small for a queen bee to pass through.

As used herein, the term “queen excluding grid” means a grid structure which is placed between a hive body and a honey super to form a physical barrier that contains openings too small for a queen bee to pass through.

As used herein, the term “foldably” means capable of being bent along a straight axis to form a ninety degree angle

As used herein, the term “machine cut” means cut, stamped, extruded, laser cut, die cut, CNC machined or otherwise formed from a single sheet of metal.

As used herein, the term “selectively attachable” means a component capable of being attached or removed.

### BACKGROUND

An apiarist is a person skilled in the art of beekeeping, or raising bees to manufacture honey in man-made habitats. Traditionally, apiaries (known in the art as “bee yards”) include several dozen hives on a parcel of land. Apiarists may maintain up to a hundred or more bee colonies, and travel on foot to maintain each bee colony.

A beehive is a structure in which honey bees live, raise their young and produce surplus honey. A bee hive's beehive's internal structure is a densely packed matrix of hexagonal cells made of “beeswax” (a substance produced by bees). This structure of cells is called a honeycomb. The bees use the cells to store food (honey and pollen), and to house the “brood” (eggs, larvae, and pupae). A beehive may be constructed by a bee colony in a natural habitat, or man-made.

A beehive, whether naturally occurring or man-made, includes at least one frame and at least one cell. The frame is the structure which supports a matrix of hexagonal cells made of beeswax within a honeycomb.

The cell is a compartment which is made of beeswax within a honeycomb, and may contain bee larvae and/or food to nourish bees.

Man-made bee habitats consist of multiple frames in which honeycombs are built by bees. Other structural components within a man-made bee hive include: a bottom board, one or more hive bodies, one or more honey supers, a queen excluding grid and/or a lid. These components are modular in nature and generally of standard dimensions known in the art.

The bottom board is the bottom portion comprised of a bottom surface and at least three vertical side structures. The three side structures partially encloses the bottom portion of a bee habitat. The unenclosed side forms an opening for the exit and entry of bees from the bee habitat. The hive body is a four sided frame structure that may be used as a modular component of a bee habitat.

The honey super is a four sided frame structure that can used as a component of a bee habitat, and which is smaller than a hive body, but which functions solely to store honey produced by the bee colony. Generally a bee queen is precluded from entering the honey super portion of a bee habitat by a grid (called a “queen excluding grid”) which is placed between a hive body and a honey super that contains openings too small for a queen bee to pass through. The honey in the portions from which the queen bee is excluded can be harvested for sale and use by the apiarist.

A problem known in the art is the difficulty of maintaining bee habitats in a wide range of outdoor climates. Bees thrive more readily in wooden habitats, as opposed to habitats constructed of synthetic materials. Wood is a material of choice for constructing most modular components of a bee habitat because it is an organic, naturally occurring plant material which simulates the natural habit of bees.

However, wood is prone to warping, rot, splitting and other conditions of wear caused by weather conditions and animals. Since man-made bee habitats known in the art are constructed from multiple wooden components, the bee habitat components are particularly prone to wear and damage at the corners and joints.

Apiarists must maneuver over outdoor area where the bee habitats are located to repair and maintain them. A single apiary may contain thousands of habitat structures. The amount of time which an apiarists must spend repairing and maintaining the wooden habitats, while live colonies inhabit them year-round, determines the apiarists profitability and productivity.

In the event that a hive body or honey super becomes worn, damaged or degraded, a bee keeper must perform the task of disassembling the modular components of the bee habitat (including taking apart the hive bodies, frames and honey supers). This is a time consuming repair task, particularly because the apiary maintains multiple bee habitats over a “bee farm” which may extend several acres or miles.

Generally, most of an apiarists maintenance time is spent repairing stress and damage at the corners and joints of bee hive bodies and honey supers. This maintenance requires time-consuming maintenance and replacement of bee hive bodies and honey super components which must be removed from the structure and repaired on the premises, or the entire bee habitat structure must be transported.

Additionally, wear along the corners and joints of a bee habitat, if undetected, can cause unsealed openings in the bee habitat structure. These openings allow mice, rates, insects, shrews, small mammals and other undesirable species to enter the bee habitat during cold winter months. During the winter months, bees survive relatively harsh winter conditions through the act of clustering. During clustering, the bees in the colony congregate together to conserve heat within the structure. While clustering, bees are unable to defend themselves against invasive animals and insects. It may be difficult to detect weak points within a wooden structure that are rotted or weakened and can be compromised for animals and insects to gnaw or enter, and currently there is no device known in the art which enables a apiarist to proactively prevent invasive animals from detecting weak points at the corners and joints of a bee habitat.

Attempts have been made in the art to construct beehives with materials other than wood.

However, metal, plastic, metal or plastic lined bee habitats are more resistant to the rotting and weakening to which wood is prone; however, these materials are impractical in many winter-summer climates because they provide poor insulation to control temperatures within the bee habitat. Foam bee habitats provide better insulation, but are extremely expensive.

Many artificial materials from which bee habitats are constructed are known to give off highly volatile amines that are harsh to the skin and eyes of humans. Needless to say, the bees do not tolerate the release of such hazardous chemicals within their habitat. In an effort to overcome the release of these chemicals, the artificial hives have even been allowed to age for months outside before receiving a new colony of bees. Although this often reduces the levels of chemicals within the hive to permit inhabitation, it is generally recognized that bees residing in these aged structures do not produce as much honey as those in housing composed of natural materials.

It economically desirable for apiarists to limit the time they must spend to repair, transport and or replace the outer wood structures of the hive frequently.

It is further desirable to have a protective device which allows an apiarist to prevent entry by intrusive animals and insects that detect and exploit weak areas of the corners and joints of the wooden bee habitat structure.

It is desirable to extend the life of wooden bee habitats and reduce the maintenance associated with wooden bee habitat structures, particularly for bee keepers that must profitably maintain multiple structures.

It is further desirable to have an apparatus which can be used to repair and reconstruct worn or rotted corners of wooden bee habitat structures quickly and without the use of special tools or the requirement of transporting the bee habitat for repair.

It is further desirable to have an apparatus for repairing wooden bee hive structures which can be economically mass produced, transported and utilized in the field without special training for bee keepers and workers.

### SUMMARY OF THE INVENTION

The present invention is a structural reinforcement apparatus for a wooden bee habitat constructed of a single piece of machine cut sheet metal which can be formed to create a first rectangular horizontal surface, a second rectangular horizontal surface foldably positioned a right angle to said first rectangular top surface, a first rectangular vertical surface foldably positioned at a right angle to said at least first rectangular horizontal surface, a second rectangular vertical surface foldably positioned at a right angle to said first rectangular horizontal surface; and a third rectangular vertical surface foldably positioned at a right angle to said second rectangular horizontal surface.

Various embodiments of the invention may include notches, slots and apertures to further accommodate the contours of a bee habitat component.

### DETAILED DESCRIPTION OF INVENTION

For the purpose of promoting an understanding of the present invention, references are made in the text to exemplary embodiments of a structural reinforcement component for a wooden bee habitat only some of which are described herein. It should be understood that no limitations on the scope of the invention are intended by describing these exemplary embodiments. One of ordinary skill in the art will readily appreciate that alternate but functionally equivalent may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale, instead emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related. For example, structural reinforcement component for a wooden bee habitat may be of varying shapes and sizes, and constructed of more or fewer modular components.

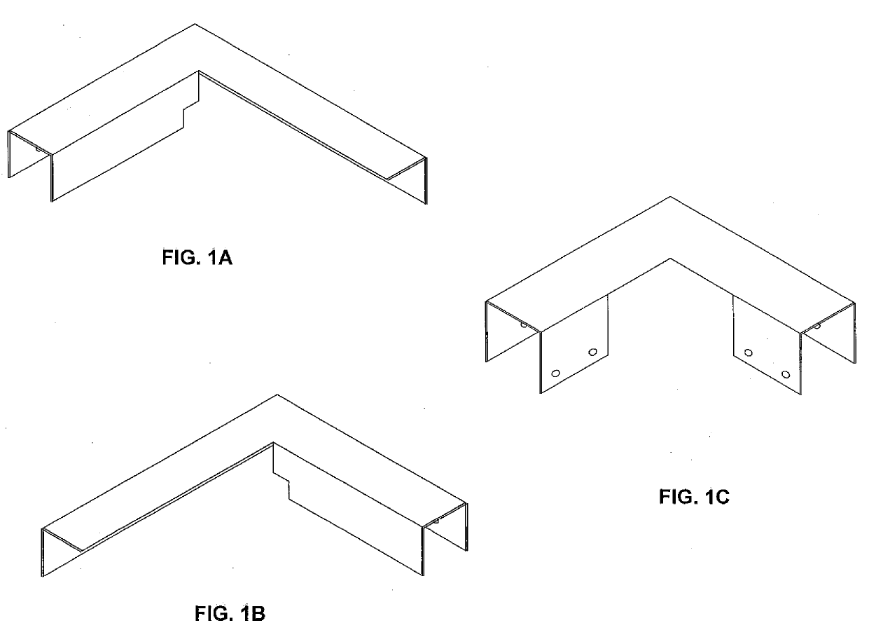

FIGS. 1a, 1b and 1c illustrate exemplary embodiments of a structural reinforcement component for a wooden bee habitat 100. In the embodiments shown, structural reinforcement component 100 is constructed of twenty gauge metal which has been laser cut or stamped and bent by a machine to form a three sided structure which is of a size that conforms to the dimension of a corner and edge, a hive body, lid, bottom board and/or honey super component of a bee habitat. The foregoing components to a standard wooden bee habitat are of lumber having a three-quarter inch thickness, and thus are adapted to receive a structural reinforcement component for a wooden bee habitat 100 having uniform dimensions. Reinforcement component for a wooden bee habitat 100 can be economically mass produced from a single sheet metal component made by a cut and folded by machining processes. Once constructed, reinforcement component for a wooden bee habitat 100 may be easily slid over the corner and/or joint portion of a bee habitat by an apiarist working in the field in a single motion, within a few seconds, and nailed into place using short nails (or brads) known in the art. This repair can be efficiently performed by apiary workers and assistants with little or no training.

Once in place, structural reinforcement component for a wooden bee habitat 100 repairs and reinforces the joint and corner portions of a wooden bee habitat, and reinforces these portions of the bee habitat to prevent invasive animals and insects from exploiting structural weaknesses.

In the embodiment shown in FIG. 1a, reinforcement component for a wooden bee habitat 100 is adapted for use on the top left corner and edge of a hive body or honey super.

In the embodiment shown in FIG. 1b, reinforcement component for a wooden bee habitat 100 is adapted for use on the top right corner and edge of a hive body or honey super.

In the embodiment shown in FIG. 1c, reinforcement component for a wooden bee habitat 100 is adapted for use on a bottom edge of a hive body or honey super, or on any edge and corner of a bottom board or lid.

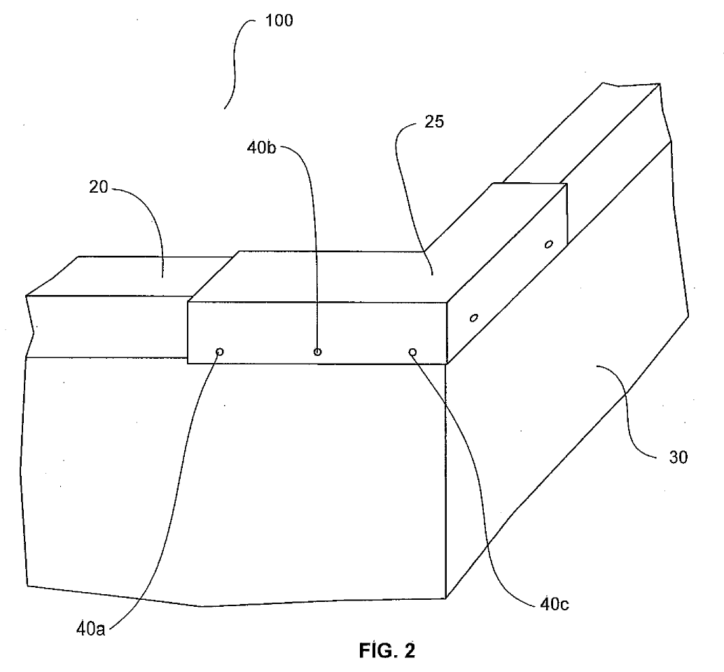

FIG. 2 illustrates an exemplary embodiment of reinforcement component for a wooden bee habitat 100 in use the top right edge 20 and corner 25 of a hive body 30 in the embodiment shown, reinforcement component for a wooden bee habitat 100 fits snugly around the outer edge and corner of hive body 30.

Component for a wooden bee habitat 100 is easily slid into place over the top right edge 20 and corner 25 of a hive body 30. In the embodiment shown Component for a wooden bee habitat 100 further includes apertures 40a, 40b, 40c, 40d (not visible), 40e (not visible), 40f (not visible) and 40g (not visible) which operate as holes into which nails or screws can be placed to hold component for a wooden bee habitat 100 in place. Alternative embodiments may have more or fewer apertures, or may omit apertures and be secured by pressure, alternative structural components and/or adhesive.

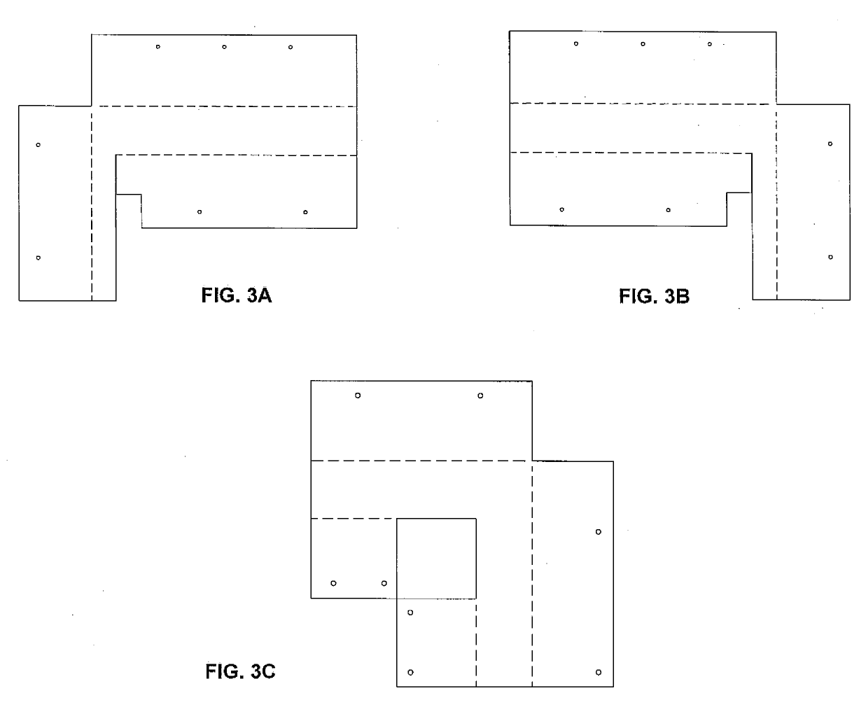

1. FIGS. 3a, 3b and 3c illustrate the design layout for cutting a piece of metal to form embodiments of component for a wooden bee habitat 100. The embodiments shown are cut so that the sheet metal components form a plurality of horizontal components, and vertical components and notches shaped to conform to the structural contours of a bee hive component. Various embodiments may also include one or more apertures of the use of nails.

In the embodiment shown in FIG. 3a, illustrates the design configuration for forming an embodiment of reinforcement component for a wooden bee habitat 100 for use on the top left corner and edge of a hive body or honey super.

In the embodiment shown in FIG. 3b, illustrates the design configuration for forming an embodiment of reinforcement component for a wooden bee habitat 100 for use on the top right corner and edge of a hive body or honey super.

In the embodiment shown in FIG. 3c, illustrates the design configuration for forming an embodiment of reinforcement component for a wooden bee habitat 100 for use on a bottom edge of a hive body or honey super, or on any edge and corner of a bottom board or lid.

What is claimed is:

1. A structural reinforcement apparatus for a wooden bee habitat constructed of a single piece of machine cut sheet metal comprised of:
a first rectangular horizontal surface;
a second rectangular horizontal surface foldably positioned a right angle to said first rectangular top surface;
a first rectangular vertical surface foldably positioned at a right angle to said at least first rectangular horizontal surface;
a second rectangular vertical surface foldably positioned at a right angle to said first rectangular horizontal surface; and
a third rectangular vertical surface foldably positioned at a right angle to said second rectangular horizontal surface.

2. The apparatus of claim 1 wherein said first rectangular horizontal surface has dimensions of at least three-quarters in width and at least 4 inches in length.

3. The apparatus of claim 1 wherein said first rectangular horizontal surface has dimensions of at least three-quarters in width and at least 3 inches in length.

4. The apparatus of claim 1 wherein said second rectangular horizontal surface has dimensions of at least three-eighths of an inch in width and at least three inches in length.

5. The apparatus of claim 1 wherein said second rectangular horizontal surface has dimensions of at least three-quarters of an inch in width and at least three inches in length.

6. The apparatus of claim 1 wherein said first rectangular vertical surface has dimensions of at least 1.1 inches in width and at least 3 and ⅝ inches in length.

7. The apparatus of claim 1 wherein said first rectangular vertical surface has dimensions of at least 1.1 inches in width and at least 2 and ¼ inches in length.

8. The apparatus of claim 1 wherein said second rectangular vertical surface has dimensions of at least 1.1 inches in width and at least 4 inches in length.

9. The apparatus of claim 1 wherein said second rectangular vertical surface has dimensions of at least 1.1 inches in width and at least 2 and ¼ inches in length.

10. The apparatus of claim 1 wherein said third rectangular vertical surface has dimensions of at least 1.1 inches in width and at least 3 inches in length.

11. (canceled)

12. The apparatus of claim 1 which further includes a fourth rectangular vertical surface.

13. The apparatus of claim 12 wherein said fourth rectangular vertical surface has dimensions of 1.1 inches in width and 3 inches in length.

14. The apparatus of claim 1 which further includes a machine-cut slit located between a horizontal surface and a vertical surface.

15. The apparatus of claim 1 which further includes a machine-cut slit located between two vertical surfaces.

16. The apparatus of claim 1 wherein first rectangular vertical surface has a notch to accommodate the contour of the upper frame of a bee habitat component selected from a group consisting of a hive body and a honey super.

17. The apparatus of claim 1 which further includes at least one aperture to accommodate a nail.

18. A structural reinforcement apparatus for a wooden bee habitat comprised of a single metal sheet cut to form:
a first rectangular horizontal surface having dimensions of at least three-quarters in width and at least 4 inches in length;
a second rectangular horizontal surface positioned a right angle to said first rectangular horizontal surface, and having dimensions of at least three-eighths of an inch in width and at least three inches in length;
a first rectangular vertical surface positioned at a right angle to said first rectangular horizontal surface and having the dimensions of at least 1.1 inches in width and at least 3 and ⅝ inches in length;
a second rectangular vertical surface positioned at a right angle to said first rectangular horizontal surface and having the dimensions of at least 1.1 inches in width and at least 4 inches in length;
a third rectangular vertical surface positioned at a right angle to said second rectangular horizontal surface and having the dimensions of at least 1.1 inches in width and at least 3 inches in length;
at least one machine-cut slit between two surfaces; and
at least one aperture to accommodate a nail.

19. The apparatus of claim 18 which further includes a fourth rectangular vertical surface having dimensions of 1.1 inches in width and 3 inches in length.

20. A wooden bee habitat having at least one selectively attachable structural reinforcement component, said structural reinforcement component comprised of:
a first rectangular horizontal surface having dimensions of at least three-quarters in width and at least 4 inches in length;
a second rectangular horizontal surface positioned a right angle to said first rectangular horizontal surface, and having dimensions of at least three-eighths of an inch in width and at least three inches in length;
a first rectangular vertical surface positioned at a right angle to said first rectangular horizontal surface and having the dimensions of at least 1.1 inches in width and at least 3 and ⅝ inches in length;
a second rectangular vertical surface positioned at a right angle to said first rectangular horizontal surface and having the dimensions of at least 1.1 inches in width and at least 4 inches in length;
a third rectangular vertical surface positioned at a right angle to said second rectangular horizontal surface and having the dimensions of at least 1.1 inches in width and at least 3 inches in length;
at least one machine cut slit between two surfaces; and
at least one aperture to accommodate a nail.

21. The apparatus of claim 18 which further includes a fourth rectangular vertical surface having dimensions of 1.1 inches in width and 3 inches in length.
